(19) United States
(12) Patent Application Publication
(10) Pub. No.: US 2025/0115145 A1
(43) Pub. Date: Apr. 10, 2025

(54) CHARGING SYSTEM FOR ELECTRIC DRIVE VEHICLES

(71) Applicant: Kenneth Barton GOULD, Rotterdam (NL)

(72) Inventor: Kenneth Barton GOULD, Rotterdam (NL)

(21) Appl. No.: 18/729,407

(22) PCT Filed: Jan. 18, 2023
(86) PCT No.: PCT/NL2023/050023

§ 371 Date: Jul. 16, 2024

(30) Foreign Application Priority Data
Jan. 19, 2022 (NL) 2030621

(51) Int. Cl. B60L 53/31; B60L 53/30; B60L 53/36; B60L 53/53

(52) U.S. Cl. CPC B60L 53/31; B60L 53/305; B60L 53/36; B60L 53/53

(57) ABSTRACT

Described is a system for charging a battery of an electric drive vehicle at variable charging locations, which battery is designed to provide the energy for the electric drive of the vehicle, comprising a stationary charging station connected to a fixed electricity network, one or more mobile charging devices, which mobile charging device comprises a battery pack; means of connection to the stationary charging station for establishing an electrical connection between the battery pack and the fixed electricity network; driving means to drive the mobile device, such that the mobile device can move from the stationary charging station to a number of charging locations remote from the charging station which charging locations are arranged for positioning the electric drive vehicle, and back; and means for delivering electrical energy from the battery pack to the vehicle battery, the system being designed to deliver electrical energy from the one or more mobile charging devices connected to the stationary charging station back to the electricity network in the event of decreased capacity of the fixed electricity network. It also describes a method for charging a battery of one or more electric drive vehicles at variable charging locations, which battery is intended to provide the energy for the electric drive of the vehicle, which charging locations are arranged for positioning the electric drive vehicle, under application of the system. A mobile charging device and a connection element between a mobile charging device and the vehicle to be charged are also described.

The invention relates to a charging system for charging a battery of an electric drive vehicle at variable charging locations, which battery is intended to provide energy for the electric drive of the vehicle, comprising:
1) a stationary charging station connected to a fixed electricity network, which stationary charging station comprises a number of stationary coupling means arranged to provide a coupling and an electrical connection between the stationary charging station and
2) a plurality of mobile charging devices, each mobile charging device comprising:
   i. battery pack;
   ii. mobile coupling means arranged to couple with one of the stationary coupling means of the stationary charging station and to establish an electrical connection between the battery pack and the stationary charging station;
   iii. means for moving the mobile charging device from the mobile charging station to a number of charging locations remote from the stationary charging station which charging locations are arranged for positioning the electric drive vehicle, and back again; and
   iv. means for delivering electrical energy from the battery pack to the battery of the vehicle.

The invention further relates to a method for charging electric drive vehicles with the charging system, to a stationary charging station that is part of the charging system, to a connection element for use in the system, to a mobile charging device that is part of the charging system and to an app for charging an electrically powered vehicle with the system.

Nowadays there is an ever-growing shift from fossil-fuel-powered vehicles to electric drive vehicles. This brings along necessary challenges. For instance, the number of charging points in public spaces is limited and the existing charging points may be kept occupied for an unnecessarily long time due to a vehicle not being moved by its owner promptly after charging. Also, with the increasing demand for charging, much more capacity is required from the fixed electric networks, which often cannot cope with the demand. Such a fixed electrical network is used for general electricity supply to households and industry, for example, and is usually fed by a power plant.

Such a system is known from CN111791729A. However, in this system, a stationary battery that is part of the stationary charging station is first charged from the fixed electricity network, and mobile charging devices, implemented as self-driving trolleys, are charged from the stationary battery.

Due to the presence of a stationary battery, the stationary charging station is large in size and requires a great deal of space. The system is therefore not well suited for implementation in most urban environments. Furthermore, the presence of such a battery for intermediate storage of electrical energy is concomitant with an increased risk of fire and other hazards. Also, the return delivery of electrical energy from the system to the fixed energy network is not described for this system.

The invention aims to provide an improved system of the above-mentioned type and is characterised thereto in that the system is arranged to supply electrical energy from the one or more mobile charging devices connected to the stationary charging station to the electricity network. The system is therefore suitable for buffering peaks and troughs in the fixed electricity network. At times when the capacity of the electricity network is insufficient, the mobile charging devices connected to the stationary charging station can return the electrical energy stored therein to the fixed electricity network, thereby acquiring the function of storage buffer. Interference or ‘noise’ on the network may also occur, for example, when the fixed electricity network is fed with electrical energy by different sources; this noise can be at least partly mitigated by the battery packs of the mobile charging devices. Because the electrical energy is delivered from the mobile devices directly to the fixed electricity network, an intervention of a stationary battery for storing electric energy in the stationary charging station is not necessary, which allows the mobile charging stations to be simpler, more compact and safer, improving the feasibility of implementation in an urban environment.

Herein, the ‘vehicle battery’ refers to the electric battery or batteries that provide the electric energy used to drive the vehicle. Herein, the term ‘starter battery’ will be used to refer to the storage of electrical energy that is not intended to drive the vehicle. Thus, according to this nomenclature, cars powered purely by fossil fuel do not contain a vehicle battery but rather a starter battery, while cars with a fuel engine that can charge a battery that in turn powers the car do indeed have a vehicle battery, with the fuel engine also referred to as range extender. References to ‘charging a vehicle’ herein refer to charging the vehicle battery of the electric drive vehicle.

The electric drive vehicle can be any vehicle, especially for transporting people and/or goods, especially a four-wheeled vehicle, especially a car, such as a passenger car, a van or a truck. However, the vehicle can also be, for example, an electrically powered motorbike. The system itself is also suitable for electrically powered light vehicles such as bicycles and wagon carts et cetera, although the battery of such a light vehicle can also be easily charged at home. The system is therefore particularly intended for larger vehicles such as cars and possibly motorbikes.

The stationary charging station is situated in a permanent location, such as in a public space near parking locations suitable or intended for parking electrically powered vehicles, or for example in parking lots or garages. The stationary charging station is connected to a fixed electricity network and includes a plurality of stationary coupling means arranged to provide a coupling and electrical connection between the stationary charging station and a plurality of mobile charging devices. The mobile charging devices, executed for example as self-driving trolleys, have a battery pack and mobile coupling means by which the respective mobile device can be coupled with the stationary charging station, thereby realizing an electrical connection between the stationary charging station and the battery pack of the mobile charging device. Thus, a plurality of mobile charging devices can be simultaneously coupled with the stationary charging station and the battery packs of the mobile charging devices can be charged from the stationary charging station.

The mobile charging device may be manually or automatically disconnected from the stationary charging station, after which the mobile charging device may be moved from the stationary charging station to a remote charging location such as a parking space. At this charging location, an electrically driven vehicle may be positioned to be charged from the battery pack of the mobile charging device. For this purpose, the mobile charging device possesses means for delivering electrical energy from the battery pack to the battery of the vehicle. Such means may include a plug that may be manually or automatically inserted into a socket of the vehicle to be charged in order to establish an electrical connection between the battery pack of the mobile charging station and the battery of the electrically driven vehicle. Such means may also include a robotic arm capable of automatically establishing an electrical connection between the mobile charging device and the battery pack of the vehicle to be charged. The connection may also be established wirelessly. Establishing the connection may be done manually or automatically. The term ‘variable’ charging locations means that the system is arranged for charging vehicles at a number of locations located at different distances from the stationary charging station, where the distance is such that it is not bridged by a physical electrical connection between the stationary charging station and the vehicle to be charged. The charging location is thus not necessarily dictated by the presence of an electric charging connection point and may thereby include any remote parking location that is accessible to the mobile charging device.

After the vehicle has been fully or partially recharged, or supplied with a predetermined amount of electrical energy, the connection can be disconnected after which the mobile charging device can be moved back to the stationary charging station for recharging.

With such a system, many more parking locations become suitable for charging an electrically powered vehicle, especially an electric car, and a stationary charging station can charge and accommodate several mobile charging devices simultaneously. Thus, fewer fixed charging points are needed and thus less infrastructure intervention is required compared to currently known systems and fixed charging stations to cover a larger operating area.

In particular, the stationary charging station, when coupled with a mobile charging device, is designed to provide an electrical transfer between the fixed electricity network and the mobile charging device, whereby the battery pack is brought in direct connection with the fixed electricity network. The electrical transfer is thus direct, i.e. without the intervention of additional storage means such as a stationary battery as known in the art.

Due to the above-mentioned advantages, the stationary charging station is therefore preferably free of storage means, such as one or more stationary batteries, which are intended to store electrical energy from the fixed electricity network before releasing it to one or more mobile charging devices. Still, it remains an option to equip the stationary charging station with stationary batteries that are charged by the fixed electricity network and that store electrical energy locally for subsequent release to the mobile charging devices. To this end, the stationary charging station may, for example, be equipped with a control device that, in the event of excess capacity of the fixed electricity network, feeds both the mobile charging devices and one or more stationary batteries, and as soon as the capacity decreases the energy may be preferentially used to charge the mobile charging devices.

Because the delivery of electrical energy back to the fixed grid takes place directly from the mobile charging devices, such optional stationary batteries can be designed much less heavy duty.

Still, to enable the stationary charging station to be as compact and safe as possible, the stationary charging station is preferably free of storage devices that are intended to store electrical energy from the fixed electricity network and to release it back to fixed electricity network.

Although the invention also provides for the possibility of manually disconnecting a mobile charging device from a stationary charging station and moving it to a vehicle to be charged, and then back again, it is preferred that the mobile charging devices are self-driven. To this end, in an attractive embodiment, each of the plurality of mobile charging devices includes driving means arranged to drive the respective mobile charging device. Displacing the mobile charging station to the charging location for charging the electric vehicle, such as an electric car, can therefore be fully automatic. After the charging operation is completed, the mobile charging device can drive itself back to the stationary charging station without having to wait for the user to return and can then be efficiently recharged for the next use. Such self-driving systems are known, for example, from DE 102107009237A, which describes a self-driving trolley with a battery pack, which trolley can be connected to the fixed electricity network to recharge the battery pack. The trolley can then independently drive to a certain location and charge an electric vehicle on the spot. To this end, the trolley has a robotic arm to establish a power connection between the battery pack of the trolley and the vehicle battery. Such trolleys are also known for, for example, delivering mail.

The system is advantageously designed to receive information about the electric vehicle and the location where it is or will be parked. An electric vehicle to be charged may emit a signal or a command that is received by the system, providing information about, for example, the parking location where the vehicle is or will be located, the amount of energy required, and/or about the length of parking time during which the vehicle is available for charging. This allows the system to check whether a suitable mobile charging device is available, or select the most suitable one, and make it available for charging the vehicle in question. When the mobile charging device is manually retrieved, the system can break the link between the stationary charging station and the designated mobile charging device, making it available for moving to and for charging the vehicle.

When the system provides for a self-driving mobile charging device, the system can direct the most suitable charging device to the respective charging location. Thus, in an attractive embodiment, the mobile charging device is arranged to automatically move to the respective charging location based on the charging location information received by the system.

Information regarding the charging location and/or the vehicle can be sent to the system by the vehicle itself, or by a user, or by a combination of both.

Once the mobile charging device is at the charging location where the vehicle to be charged is parked or will be parked, the electric energy of the mobile charging device is to be transferred to the battery of the electric drive vehicle. To this end, an advantageous embodiment of the system comprises a connection element arranged to be electrically connected to the mobile charging device at a charging location, which connection element may be brought in cooperation with a charging connection point of the vehicle in order to transfer electrical energy from the battery pack of the mobile charging device to the battery of the vehicle. The term “vehicle charging connection point” means the point on the vehicle where connection to the vehicle battery can be made with a charging cable or other device for transferring electrical energy such as, for example, a robotic arm.

The connection element acts as a bridge between the mobile charging device and the electric vehicle to be charged. The mobile charging device is brought into electrical connection with the connection element and may employ here for the coupling means that are also used to couple the mobile charging device with the stationary charging station. The connection element may be such that an electrical coupling between the connection element and the mobile charging device may take place automatically by having the mobile charging device docked to the connection element. Because the charging connection points of vehicles of different makes may differ in form, the connection element may be advantageously provided with various coupling means to enable electrical connection to such different vehicles. Such coupling means may include, for example, a number of differently shaped sockets or adapters to which a charging cable of an electric vehicle may be connected.

Also, the coupling means may include control elements by which electrical energy is provided in a manner appropriate for the particular vehicle, accommodating the specific voltage and current supply needs of different vehicles.

In an attractive embodiment, the connection element is positioned stationary near one or more charging locations. ‘Stationary’ here means that it is permanently installed at a location and cannot be removed without disassembly. For example, the connection element may be designed as a pillar or flat plate that is level with the road surface or pavement next to the loading location. The connection element may also include marking means for indicating the charging location, so that it is clearly recognizable that at this location an electrically powered vehicle can be charged with the system. The mobile charging device can dock with the connection element, creating an electrical connection between the mobile charging device and the connection element. The mobile vehicle can be connected to the connection element via coupling means described above, such as a charging cable from the electric vehicle. The user can connect this charging cable to the connection element. It is also possible that the connection element is provided with means, such as a robotic arm, which automatically provides connection to the charging socket of the vehicle to be charged.

In this way, the mobile charging device is secured during the delivery of electrical energy. The cooperation between the stationary connection element and a charging point of the vehicle to be charged can take place, for example, by connecting a cable between the stationary connection element and the charging point of the vehicle to be charged, such as a socket fitting with the cable. The user of the vehicle to be charged may park his vehicle at the charging location, connect to the connection element and go to pick up a mobile charging device at the stationary charging station or have it come from there. The electrical connection between the mobile charging device and the stationary connection element may be established manually by, for example, the user by coupling the mobile charging device with the connection element. It is also possible that the mobile charging device and the stationary connection element are situated to be electrically connected automatically. In that case, the user does not have to wait for the arrival of the mobile charging device. The user then only connects his vehicle to the connection element. To this end, the connection element may include communication means for sending a command or information to the stationary charging station, as well as a user interface such as a touch screen for receiving commands and/or information by the user and sending it to the stationary charging station. This information may include charging specifications for the vehicle to be charged, such as voltage and charging current.

In another very attractive embodiment, the connection element is portable. By ‘portable’, it is meant that it can be moved manually or with the aid of an instrument, preferably without the necessity to dismantle the connection element. In such an embodiment, the connection element may be part of the equipment carried by the electric vehicle, and when the vehicle needs to be recharged, the user may place the connection element in an accessible location for the mobile charging device whereby the connection element is connected to the vehicle so that an electrical connection can be established between the mobile charging device and the battery of the vehicle. To this end, the connection element is placed outside the vehicle, for example, and at an intended charging location there may be a specially designated place where the connection element can be placed. This spot may be equipped with means to secure and/or lock the connection element in position, facilitating pairing with a mobile charging station, and preventing unwanted removal of the connection element. In such an embodiment, the construction of stationary connection elements at the charging locations is not necessary.

It is also possible for the transfer of electrical energy from the mobile charging device to take place directly with the vehicle to be charged, i.e. without the intervention of a connection element.

In an attractive embodiment, the means for transferring electrical energy from the battery pack of the mobile charging device to the battery of the vehicle comprises a transfer element, which transfer element may or may not be brought into cooperation with the vehicle charging point in order to transfer electrical energy from the battery pack of the mobile charging device to the battery of the vehicle under the intervention of the above-described connection element. This transfer element may be designed as a plug, and the vehicle charging point or stationary connection element may include a suitable power outlet, but it is also possible that the transfer element and the vehicle charging point or stationary connection element may be suitable for wireless energy transfer, which facilitates an automatic electrical transfer connection. Such wireless energy transfer is described, for example, in EP3456278A, wherein a stationary charging station is described, but attached thereto a wheeled flat charging robot that can be driven under a vehicle to charge by induction the battery of the vehicle.

In an attractive embodiment, the system is arranged to disengage the cooperation between the transfer element and the vehicle charging point or stationary connection element after a certain charging time or amount of transferred electrical energy, after which the mobile charging device can return to the stationary charging station for recharging. For example, the system may be arranged to receive a command or information from the user or the vehicle to allow charging to take place for a predetermined time, or to limit the amount of electrical energy to be transferred to a predetermined amount. The system may also be equipped with a payment system whereby payment of a certain amount of money or for a certain amount of energy is made in advance or afterwards.

After the vehicle charging operation is completed, the mobile device may be returned manually to the stationary charging station, or the mobile device may drive itself back to the stationary charging station. To this end, the mobile charging device is advantageously designed to move back to the stationary charging station after ending the cooperation between the transfer element and the vehicle charging station and to be connected to the stationary charging station for realising an electrical connection between the battery pack and the stationary charging station, whereby the battery pack can be charged from the electricity network by means of the stationary charging station.

The stationary charging stations may also be equipped with one or more transfer elements that can be brought in conjunction with a vehicle charging socket to transfer electrical energy directly from the stationary charging station into the vehicle's battery. Such an additional embodiment corresponds to charging posts as currently used in public areas for charging electric vehicles.

The invention also provides a process for charging a battery of one or more electrically driven vehicles at one or more charging locations, which battery is intended to provide the energy for the electric drive of the vehicle, which are arranged for positioning the electrically driven vehicle, under application of the system as described above, comprising the steps:
1) providing information to the system about the charging location and the electric vehicle that is or will be parked at that location;
2) disconnecting a mobile charging device that is coupled with the stationary charging station;
3) moving the mobile charging station to the charging location of step 1);
4) bringing the transfer element of the mobile charging device into cooperation with the vehicle charging point at the charging location;
5) transferring electrical energy from the battery pack of the mobile charging device to the battery of the vehicle;
6) disengaging the cooperation between the transfer element of the mobile charging device and the vehicle charging point after a certain charging time or amount of transferred electrical energy;
7) moving the mobile charging device from the charging location back to the stationary charging station; and
8) connecting the mobile charging device with the stationary charging station to establish an electrical connection between the battery pack and the stationary charging station, such that the battery pack can be charged from the fixed electricity network under the intervention of the stationary charging station.

The charging of the battery pack via the stationary charging station from the fixed electricity network is preferably carried out without the intervention of storage means intended to store electrical energy from the fixed electricity network before transferring it to one or more mobile charging devices. The charging then does not involve staged charging first from the fixed electricity network to such storage means, such as a stationary battery as known from CN111791729A, followed by charging of the mobile charging devices by the stationary battery. The charging of the mobile charging devices thereby takes place directly from the fixed electricity network.

In a special embodiment, one or more of the steps 2)-8) take place without user intervention. This means that the system performs the relevant step itself, without requiring a user of the system to execute the relevant step. For example, disconnection may take place automatically in response to receiving a command to that effect, or due to the proximity of a specific user, for example by the user carrying a specific tag, which may or may not be temporarily activated. Preferably, the mobile charging device can drive itself to the indicated charging location and preferably initiate and disconnect the electrical connection to the vehicle itself, after which the mobile charging device preferably drives itself back to the stationary charging station in order to be reconnected to it. In a highly attractive embodiment, steps 2), 3), 7) and 8), and more preferably steps 2) through 8) take place automatically without user intervention.

The invention also provides for a method for feeding an electricity network using the system as set out above, comprising the step of transferring electrical energy from the battery pack of one or more mobile charging devices coupled to the stationary charging station back to the fixed electricity network.

The invention also provides for a stationary charging station as defined herein, which is electrically connected to the fixed electricity network, comprises stationary coupling means for coupling with one or more mobile charging devices as defined herein, and realising an electrical connection between the fixed electricity network and the battery pack of the one or more mobile charging devices, and is further arranged to detect peaks in the electricity network, and upon detection thereof, to transfer electrical energy from the fixed electricity network into the battery pack of one or more of the mobile charging devices connected to the charging station; and is designed to detect an energy shortage in the fixed electricity network and, upon detection thereof, to transfer electrical energy from the battery pack of one or more of the mobile charging devices connected to the stationary charging station to the fixed electricity network, whereby the stationary charging station is free of storage devices intended to store electrical energy from the fixed electricity network before transferring it to one or more mobile charging devices.

Such a stationary charging station is ideally suited to buffer the capacity of the fixed grid. For example, the requirement of the fixed grid can be measured using a pre-set limit.

As discussed above, the stationary charging station of the system described herein is preferably without a storage means that is intended to store electrical energy from the fixed electricity network and release it back to the fixed electricity network.

Preferably, the stationary charging station is provided with a user interface for inputting data by a user regarding the user and/or the vehicle to be charged, and for receiving a command to release a mobile charging device connected to the stationary charging station. This user interface can, for example, be provided as a touch screen or a button panel that allows a user to issue commands to the system and to feed the system with information regarding the energy required, the available charging time, the charging location of the vehicle, payment information and so on.

The invention also provides a connection element as described herein.

In another embodiment, the invention provides a mobile charging device as described herein.

The invention also provides an app designed to send information to a user interface about a user and/or the electrically powered vehicle with or without information of the charging location at which the vehicle is or will be positioned, to a system as described above, and a command to release a mobile charging device connected to the stationary charging station, whether or not in combination with causing the mobile charging station to move to the designated charging location. The mobile charging station can thus automatically drive to the respective charging location, and back again. This user interface is preferably a mobile smart device, such as the widely known mobile smart phone, tablet or smart watch.

The invention will be illustrated using the following figures, which are in no way intended to limit the invention in any way.

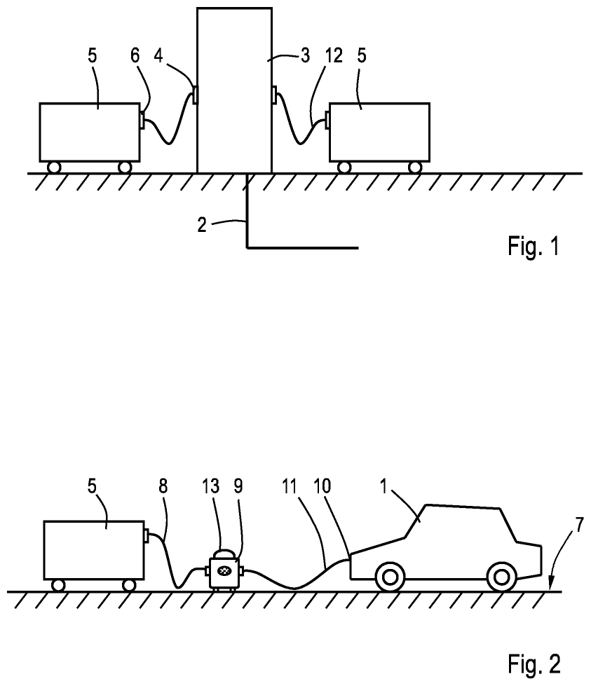

FIG. 1 is a schematic representation of a stationary charging station with which two mobile charging devices are coupled;

FIG. 2 is a schematic representation of a mobile charging device connected to an electric vehicle via a connection element.

FIG. 1 shows a stationary charging station 3, which is permanently connected to a fixed electricity network 2. Two mobile charging devices 5 are coupled to the stationary charging station 2 in the case shown, whereby an electrical connection is established between the fixed electricity network 2 and the mobile charging devices, whereby current flows from the fixed electricity network 2 to the mobile charging device and is stored in the battery pack thereof, or vice versa, whereby current is delivered to the fixed network by the battery pack of the mobile charging device 5. To this end, the stationary charging station includes stationary coupling means 4 such as, for example, an electrical contact point such as a socket, and the mobile charging station includes mobile coupling means 6 that fit to the stationary coupling means to enable an electrical connection. These may also include an electrical contact point such as a plug or socket, or a robotic arm. In the illustrated case, the coupling between the stationary charging station and the mobile charging device is simplified by a cable 12. As mentioned above, instead of a cable, a robotic arm, for example, may also be provided, either as part of the stationary charging station or as part of the mobile device.

The stationary charging station serves herein as a link between the fixed electricity network and the mobile charging devices, without the need to store electrical energy by the stationary charging station. The stationary charging station 3 may be provided with regulation and control means to control the coupling with and control of the mobile charging devices 5. The stationary charging station may also include a user interface that allows a user to regulate on-site the supply of electrical energy to his vehicle, for example by logging into an on-site control system using a selection menu and thereby releasing a mobile charging device 5 for charging his vehicle by disconnecting the device from the stationary charging station 3. The mobile charging device 5 may then be taken by the user to charging location 7 where his vehicle 1 to be charged is parked, as shown in FIG. 2. Alternatively, the mobile charging device may be arranged to move itself from the stationary charging station 3 to the charging location 7. To this end, the user may, for example, use an app on the mobile phone with which he remotely logs into the control system and orders a mobile charging device 5. Once the mobile device has arrived at the charging location, the mobile charging device 5 may be connected to the charging connection point 10 of the vehicle 1 with energy delivery means 8, here designed as charging cable 8. It is also possible to design these means 8 as, for example, a robotic arm. In the case shown, an electrical connection is established between the mobile charging device 5 and the vehicle under the intervention of a connection element 9, which is fixed at the charging location 7, or may be mobile. Preferably, the connection element is designed such that a simple and automatic connection to the mobile charging device can be established. The user of the system then only has to manually establish an electrical connection between the connection element and the vehicle, for example by connecting the charging cable 11 belonging to the vehicle to the connection element 9. The connection element 9 may comprise control means to transfer the electrical energy with the appropriate setting of the charging parameters, such as current intensity, voltage, duration and pulsation, appropriate to the respective vehicle 1. In the case of a mobile implementation form of the connection element 9, it may include a handle 13 for easy carrying by the user in his vehicle. Such a connection element may optionally be provided with locking means for securing the connection element 9 to prevent theft. The charging location may comprise suitable fastening means for this purpose.

It is also possible to connect the mobile charging device to the vehicle without the intervention of a connection element using a transfer element. Then, for example, the charging cable 8 of the vehicle may serve as such a transfer element, or a robotic arm of the mobile charging device 5 arranged to electrically connect to the vehicle 1.

1. System for charging a battery of an electric drive vehicle (1) at variable charging locations, which battery is intended to provide the energy for the electric drive of the vehicle, and which charging locations include:
1) a stationary charging station connected to a fixed electricity network, which stationary charging station comprises a number of stationary coupling means arranged to provide a coupling and electrical connection between the stationary charging station and
2) a plurality of mobile charging devices, wherein each mobile charging device includes:
i. a battery pack;
ii. mobile coupling means arranged to couple with one of the stationary coupling means of the stationary charging station and to establish an electrical connection between the battery pack and the stationary charging station;
iii. means for displacing the mobile device from the stationary charging station to a plurality of charging locations remote from the stationary charging station which charging locations are arranged for positioning the electric drive vehicle, and back again; and
iv. means of delivering electrical energy from the battery pack to the battery of the vehicle, characterized in that that the system is arranged to supply electrical energy from the one or more mobile charging devices connected to the stationary charging station to the electricity network in case of decreased capacity of the fixed electricity network.

2. System according to claim 1, wherein the stationary charging station is designed to provide a direct electrical transfer between the fixed electricity network and the mobile charging device when coupled with a mobile charging device, wherein the battery pack is directly connected to the fixed electricity network.

3. System according to claim 1, wherein the stationary charging station is free of storage means intended to store electrical energy from the fixed electricity network before releasing it to one or more mobile charging devices.

4. System according to claim 1, wherein the stationary charging station is free of storage means intended to store electrical energy from the fixed electricity network and release it back to fixed electricity network.

5. System according to claim 1, wherein the plurality of mobile charging devices each comprises driving means arranged to move the respective mobile charging device.

6. System according to claim 1, designed to receive information about the charging location and/or the electric drive vehicle positioned or to be positioned thereon.

7. System according to claim 1, wherein the mobile charging device is designed to automatically move to the respective charging location based on the charging location information received by the system.

8. System according to claim 1, wherein the charging location information to be received by the system is controlled by a user or by the vehicle, or a combination thereof.

9. System according to claim 1, wherein the system further comprises a connection element designed to be electrically connected to the mobile charging device at a charging location, which connection element may be brought in cooperation with a charging connection point of the vehicle in order to transfer electrical energy from the battery pack of the mobile charging device into the battery of the vehicle.

10. System according to claim 9, wherein the connection element is positioned stationary near one or more charging locations.

11. System according to claim 9, wherein the connection element is detachable.

12. System according to claim 1, wherein the means for transferring electrical energy from the battery pack of the mobile charging device to the battery of the vehicle comprises a transfer element which transfer element can be brought into cooperation with a charging location of the vehicle, optionally by the intervention of the connection element, in order to transfer electrical energy from the battery pack of the mobile charging device to the battery of the vehicle.

13. System according to claim 12, wherein the system is designed to disengage the cooperation between the transfer element and the connection element or the vehicle charging point after a certain charging time or amount of transferred electrical energy.

14. System according to claim 12, wherein the mobile charging device is designed to move back to the stationary charging station, after the cooperation between the transfer element and the stationary connection element or the vehicle charging point is disengaged, and to be connected to the stationary charging station for establishing an electrical connection between the battery pack and the stationary charging station, wherein the battery pack can be charged from the electricity network under the intervention of the stationary charging station.

15. Method for charging a battery of one or more electric drive vehicles at variable charging locations, which battery is intended to provide the energy for the electric drive of the vehicle, which charging locations are arranged for positioning the electrically powered vehicle, using the system according to any one of the preceding claims, comprising the steps:
1) providing to the system information about the charging location and the electric drive vehicle positioned or to be positioned thereon;
2) disconnecting a mobile charging device connected to the stationary charging station;
3) moving the mobile charging station to the charging location of step 1);
4) bringing the transfer element of the mobile charging device into cooperation with the charging point of the vehicle at the charging location;
5) transferring electrical energy from the battery pack of the mobile charging device to the battery of the vehicle;
6) disengaging the cooperation between the transfer element of the mobile charging device and the vehicle charging point after a determined charging time or amount of transferred electrical energy;
7) moving the mobile charging device from the charging location back to the stationary charging station; and
8) connecting the mobile charging device with the stationary charging station to establish an electrical connection between the battery pack and the stationary charging station, such that the battery pack can be charged from the fixed electricity network under the intervention of the stationary charging station.

16. Method according to claim 15, wherein charging of the battery pack via the stationary charging station is carried out from the fixed electricity network without the intervention of storage means intended to store electrical energy from the fixed electricity network before releasing it to one or more mobile charging devices.

17. Method according to claim 15, wherein one or more of steps 2)-8) occurs automatically without user intervention.

18. Method according to claim 15, wherein steps 2), 3), 7) and 8), preferably steps 2) to 8) inclusive occur automatically without user intervention.

19. Method of feeding an electricity network using the system according to claim 1, comprising the step of transferring electrical energy from the battery pack of one or more mobile charging devices coupled to the stationary charging station to the fixed electricity network.

20. Stationary charging station as defined in claim 1, which is electrically connected to the fixed electricity network, comprising stationary coupling means for coupling with one or more of said mobile charging devices, and for realizing an electrical connection between the fixed electricity network and the battery pack of the one or more mobile charging devices, and is further arranged to observe peaks in the electricity network and, upon observation thereof, to transfer electrical energy from the fixed electricity network into the battery pack of one or more of the mobile charging devices connected to the charging station and is arranged to detect a need in the capacity of the fixed electricity network and, upon detection thereof, to transfer electrical energy from the battery pack of one or more of the mobile charging devices connected to the charging station to the fixed electricity network, the stationary charging station being free of storage devices intended to store electrical energy from the fixed electricity network before releasing it to one or more mobile charging devices.

21. Stationary charging station according to claim 20, wherein the stationary charging station is free of storage means intended to store electrical energy from the fixed electricity network and to transfer it back to the fixed electricity network.

22. Stationary charging station according to claim 20, wherein the charging station is provided with a user interface for entering data by a user with respect to the user and/or the vehicle to be charged, and for receiving a command to release a mobile charging device connected to the stationary charging station.

23. Connection element as defined in claim 9.

24. Mobile charging device as defined in claim 1.

25. App, designed to:
1) send information via a user interface to a system, according to claim 1, about a user and/or the electrically powered vehicle, optionally together with information about the charging location where the vehicle is or will be positioned,
2) issue a command to release a mobile charging device connected to the stationary charging station.

26. App according to claim 25, wherein the command in step 2 comprises causing the mobile charging device to move to the charging location of step 1).
